(19) United States
(12) Patent Application Publication
(10) Pub. No.: US 2007/0248318 A1
(43) Pub. Date: Oct. 25, 2007

(54) System and method for flexible mapping of AV vs record channels in a programmable transport demultiplexer/PVR engine

(76) Inventors: Stephane W. Rodgers, San Diego, CA (US); Daniel Z. Simon, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 11/394,877

(22) Filed: Mar. 31, 2006

(51) Int. Cl. H04N 5/95

(52) U.S. Cl. 386/85

(57) ABSTRACT

A method and system are provided for flexible mapping of AV vs. Record channels in a programmable transport demultiplexer/PVR engine. The method may involve processing a portion of an incoming packet, which may result in a partially processed packet. The preprocessing may comprise extracting information from the packet to configure parameters associated with the packet and storing the configured parameters in memory. The configured parameters may be based on the type of the packet, AV v. Record, and used to configure the channels used to transport the packets to decoders and Record engines, respectively. The number of channels used for AV data and the number of channels used for Record data may vary depending on the needs of the system.

### RELATED APPLICATIONS

This application is related to the following applications, each of which is incorporated herein by reference in its entirety:

U.S. patent application Ser. No. 11/273,102 filed Nov. 11, 2005;

U.S. patent application Ser. No. 11/273,282 filed Nov. 14, 2005;

U.S. patent application Ser. No. 11/344,329 field Jan. 31, 2006;

U.S. patent application Ser. No. ______ (Attorney Docket No. 16909US01) filed Mar. 30, 2006;

U.S. patent application Ser. No. ______ (Attorney Docket No. 16912US01) filed Mar. 31, 2006;

U.S. patent application Ser. No. 11/348,563 (Attorney Docket No. 16778US02) filed Feb. 7, 2006;

U.S. patent application Ser. No. ______ (Attorney Docket No. 16779US02) filed Mar. 21, 2006;

U.S. patent application Ser. No. 11/328,877 (Attorney Docket No. 16780US02) filed Jan. 10, 2006; and

U.S. patent application Ser. No. ______ (Attorney Docket No. 16917US01) filed Mar. 21, 2006.

### FEDERALLY SPONSORED RESEARCH OR DEVELOPMENT

[Not Applicable]

### MICROFICHE/COPYRIGHT REFERENCE

### BACKGROUND OF THE INVENTION

[Not Applicable]

In a video system, a stream of data generally comprises audio and video (AV) data to be handled by a decoder, and Record data to be handled by a PVR. Video systems need to have hardware to support each Record channel and/or AV channel. Separate pieces of hardware may be needed for each of the channels, where there can be multiple Record channels and multiple AV channels. Since it is difficult to alter the hardware in a system, conventional systems are limited to a fixed number of AV channels and Record channels. Even when the AV and Record are merged together, the numbers of the AV and Record channels has to remain fixed. This is unattractive to customers who may wish to use a different number of channels, and are limited to the number of channels available for each of the AV and Record. For instance, a customer may wish to record a number of separate streams that is greater than the available fixed number of Record channels available in a conventional system.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for flexible mapping of AV vs. Record channels in a programmable transport demultiplexer/PVR engine, substantially as shown in and/or described in connection with at least one of the figures, as set forth more completely in the claims.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1 illustrates a block diagram of exemplary architecture of a system, in accordance with an embodiment of the present invention

FIG. 2A illustrates a block diagram of exemplary architecture of a system 200, in accordance with an embodiment of the present invention.

FIG. 2B illustrates an exemplary layout of memory where context information is stored, in accordance with an embodiment of the present invention.

FIG. 3 illustrates a flow chart of a method for flexible mapping of AV vs. record channels in a programmable transport demultiplexer/PVR engine, in accordance with an embodiment of the present invention.

FIG. 4 illustrates a block diagram of an exemplary circuit for decoding compressed video data, in accordance with an embodiment of the present invention.

FIG. 5 illustrates a block diagram of the path of transport packets in an exemplary RAVE, in accordance with an embodiment of the present invention.

### DETAILED DESCRIPTION OF THE INVENTION

Certain embodiments of the present invention relate to processing video and audio signals. More specifically, certain embodiments of the invention relate to a method and system for flexible mapping of AV vs. Record channels in a programmable transport demultiplexer/PVR engine.

It is desirable for transport demultiplexers to perform a wide variety of tasks and deal with the different input formats.

In video/audio systems it may be desirable to support certain functions that may be handled by modern transport demultiplexers. Such functions may include, for example, receiving several streams which have been multiplexed together, and separating out whole streams or sub-streams at user discretion; parsing input formats such as, for example, MPEG Transport, Directv Transport, raw PES, DVD, raw ES, and a variety of other formats; recognizing start code or frame synchronization patterns from several different ES layers; assisting in the frame synchronization for video and audio; providing ancillary information about the incoming data to assist the downstream audio or video decoders; providing timestamp management support; providing methods for synchronizing commands from software with the data stream; providing flexibility to support new, as-yet unanticipated formats, and being able to do all of the aforementioned functions at high speeds such as, for example, 200+Mbits/sec. In this regard, a fast yet programmable solution may be desirable. Such a solution may utilize a double buffer and/or a hardware assist and may be implemented in a record audio video engine (RAVE).

In an embodiment of the invention, a RAVE may support multiple decoders that support audio and/or video decoding. The RAVE may also provide PVR record functionality, as well as providing ancillary information about the Record session, which may support the software in retrieving information about the recorded data. Therefore, the RAVE may be a block that combines Record functionalities and the audio/video transport parsing and demultiplexing functions. The RAVE may be capable of processing transport packets associated with each of the video decoding, audio decoding, and the Record functions. The RAVE may also be capable of processing fixed-length sections of non-transport data. The RAVE may be designed such that it may provide flexibility to allow for subsequent algorithmic changes as may be needed by data format changes, for example. Additionally, the RAVE may maintain a high throughput.

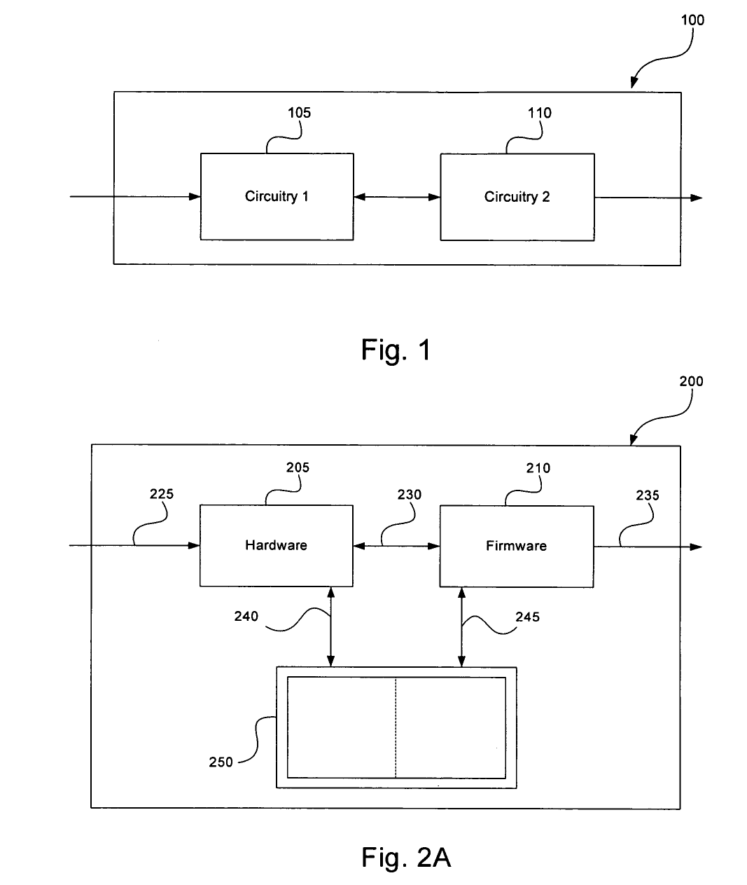

FIG. 1 illustrates a block diagram of exemplary architecture of a system 100, in accordance with an embodiment of the present invention. The system 100 may comprise a first circuitry 105 and a second circuitry 110. The system 100 processes incoming packets, where the first circuitry 105 partially processes a portion of a first packet, resulting in a partially processed first packet. The second circuitry 110 executes a set of instructions to process the remainder of the partially processed first packet. The first circuitry 105 partially processes a second packet while the second circuitry 110 is processing the remainder of the first packet. When the second circuitry 110 completes processing the first packet, the second circuitry 110 begins processing the remainder of the partially processed second packet, and at the same time, the first circuitry 105 partially processes a third packet. The processing continues where the first circuitry 105 partially processes a packet, while the second circuitry 110 processes the remainder of the partially processed previous packet.

The first circuitry 105 may process a portion of a packet, to configure parameters associated with the packet based on its data type. The data type may be AV data or Record data. The second circuitry 110 may then execute a plurality of instructions to process the partially processed packet and use the configured parameters to set up channels for AV data and Record data. The number of AV channels and Record channels may be flexibly variable based on the needs of the system. In an embodiment of the present invention, the needs of the system, and therefore the number of AV channels and Record channels may be specified by a user of the system.

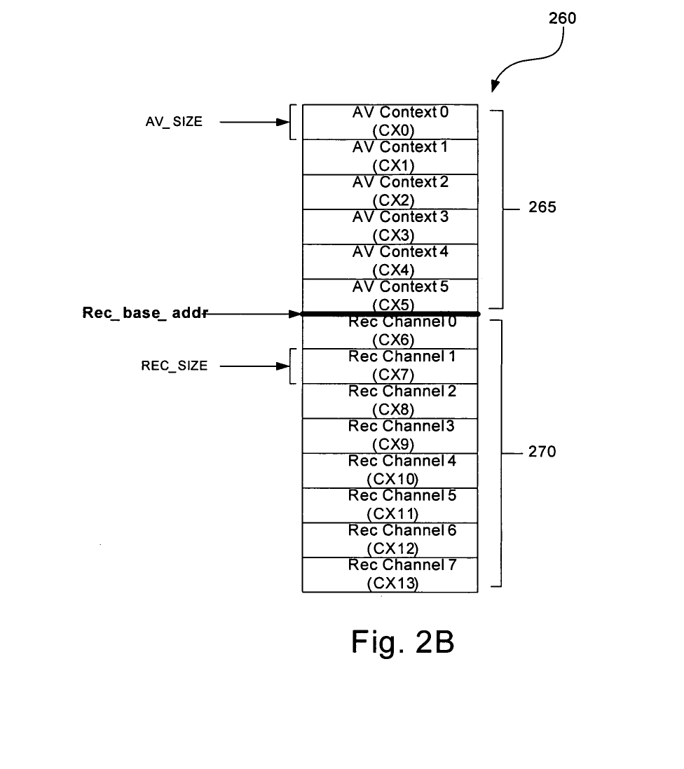

FIG. 2A illustrates a block diagram of exemplary architecture of a system 200, in accordance with an embodiment of the present invention. The system 200 may comprise a hardware assist block 205, a firmware block 210, and a memory block 250. The input data 225 may comprise packets of video, audio, and Record data.

In an embodiment of the invention, an input packet 225 may come in accompanied by information, which may comprise information that may be used to determine how the packet may be mapped to a context, for example, AV or Record. Once the packet has been mapped to a context, the hardware assist block 205 may retrieve from a portion of the memory where configurable information is stored, the configurable information associated with the context to which the packet has been mapped. The configurable information may then be used to set up the various parameters needed for the specific context. The address in memory where the parameters may be found may correspond to a context number associated with the context.

FIG. 2B illustrates an exemplary layout of memory where context information is stored, in accordance with an embodiment of the present invention. The memory where context information may be stored may be, for example, PMEM 260, which may comprise an AV context portion 265 and a Record channel portion 270. Each of the portions 265 and 270 may comprise locations identified by a context associated with an AV context or a Record channel. Each of the locations may hold the configurable information associated with the contexts/channels to which incoming packets are mapped.

Based on the context number, it may be determined whether the packet is Record or AV. For the exemplary layout of FIG. 2B, there are 6 AV contexts (CX0-CX5) and 8 Record channels/contexts (CX6-CX13). A variable indicating the number of AV contexts, Num_AV_CX, may be used to determine whether a context is AV or Record. If the context number associated with a packet is greater or equal to Num_AV_CX, then the packet is destined for a Record channel, and it the context number associated with a packet is less than Num_AV_CX, then the packet is destined for an AV channel. Other variables such as, for example, AV_size, REC_size, and Rec_base_addr may be utilized to determine the location of where data should be pulled from for a specific packet given its context number. Using this set up for storing configurable information in a portion of memory may provide the flexibility of changing the number of context used for AV and context used for Record based on the demands of the system. Setting up the desirable number of context associated with AV and Record may only be a matter of setting the variables Num_AV_CX, AV_seize, REC_size, and Rec_base_addr accordingly. Additionally, the registers associated with the memory locations of the contexts may defined according to the type of context associated with a memory location. For example, a memory location within the memory block 260 may be defined in one configuration as AV Context 7, and may have, for example, 3 registers associated with it. The registers 1, 2, and 3 may be defined to hold a certain type of data that may be associated with AV context and processing thereof. However, in another configuration, the same memory location may be defined as REC Channel 1. In such a configuration, the register 1, 2, and 3 may be utilized, and may be defined to hold a different type of data from the type defined when the memory location was defined as AV Context.

Once the configurable information is pulled out of the appropriate location associated with the context for the packet being processed, processing the packet may commence using this associated configurable information.

Referring to FIG. 2A, the hardware assist block 205 may then perform some processes and pass processed data to firmware block 210, either directly via data path 230 or indirectly via the buffer block 250. A portion of the processed data may be passed from the hardware assist block 205 via data path 240 to the memory block 250, which may then be accessed by the firmware block 210 via data path 245. U.S. patent application Ser. No. ______ (Attorney Docket No. 16779US02) filed Mar. 21, 2006, discusses several approaches of interfacing the hardware assist 205 and the firmware 210. Accordingly, U.S. patent application Ser. No. ______ (Attorney Docket No. 16779US02) filed Mar. 21, 2006, is hereby incorporated herein by reference in its entirety.

In an embodiment of the invention, input data 225 may comprise data in one of any one of a plurality of formats. The formats may vary based, for example, on the encoder used for encoding the data or the intended display for video data, etc. The input data 225 may be pre-processed in the hardware assist 205 to convert data from any format to a standardized format. The standardized format may comprise a set of information, which the firmware may process in a certain manner, regardless of the original data format. The set of information may comprise various pieces of information about the data of the packet.

The firmware 210 may utilize the various pieces of information about the incoming data packet 225 to further parse the data packet and send it to the memory 250, where the parsed data may be stored for further processing. As discussed hereinafter. U.S. patent application Ser. No. 11/328,877 (Attorney Docket No. 16780US02) filed Jan. 10, 2006 discusses information fields associated with the incoming packets, which may be utilized by the system 200 to further process the packets. Accordingly, U.S. patent application Ser. No. 11/328,877 (Attorney Docket No. 16780US02) filed Jan. 10, 2006 is hereby incorporated herein by reference in its entirety.

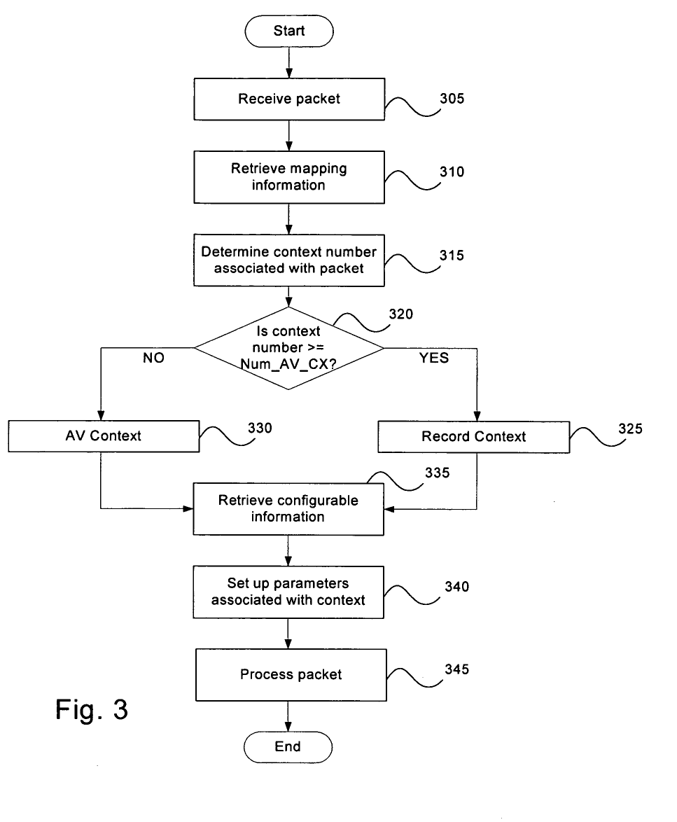

FIG. 3 illustrates a flow chart of a method for flexible mapping of AV vs. Record channels in a programmable transport demultiplexer/PVR engine, in accordance with an embodiment of the present invention. At 305 a packet may be received, where the packet may comprise AV data or Record data. The packet may be accompanied by information, which may comprise information used to determine how the packet is to be mapped to a context. The context may be AV or Record. At a next step 310, the mapping information may be retrieved. The retrieved mapping information may be then utilized to determine the context number associated with the packet at a next step 315. The context number may then be compared to the variable Num_AV_CX, which may indicate the number of AV context in the system at a next step 320. If the context number is greater than or equal to Num_AV_CX, then the context may be determined to be Record at a next step 325. If the context number is smaller than Num_AV_CX, then the context may be determined to be AV at a next step 330. At a next step 335 the configurable information may be retrieved from the memory location associated with the context number. The retrieved configurable information may then be used along with the determined type of context to set up the various parameters that may be used to process the associated packet at a next step 340. The packet may then be processed accordingly at a next step 345 as described hereinafter.

Processing of the packet may comprise the hardware assist processing at least a portion of the packet. The firmware may then access from the memory the parameters set up at step 340. The firmware may then complete processing the transport packet using the configured parameters, and direct the completely processed transport packet based on configured parameters and the associated context to the appropriate channel. AV data transports may be directed to AV decoders, and Record data transports may be directed to PVR applications.

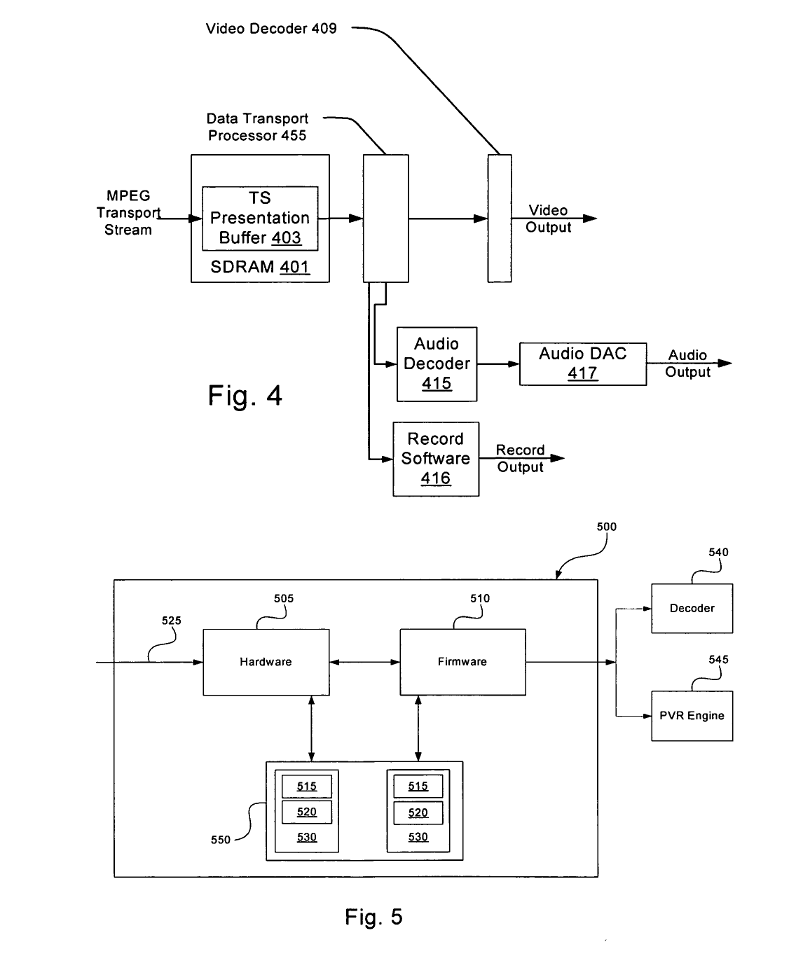

FIG. 4 illustrates a block diagram of an exemplary circuit for decoding compressed video data, in accordance with an embodiment of the present invention. Data may be received and stored in a presentation buffer 403 within a Synchronous Dynamic Random Access Memory (SDRAM) 401. The data may be received from either a communication channel or from a local memory, such as, for example, a hard disc or a DVD.

The data output from the presentation buffer 403 may then be passed to a data transport processor 405. The data transport processor 405 may demultiplex the transport stream into packetized elementary stream constituents, and passes the audio transport stream to an audio decoder 415 and to a video decoder 409, for example. The audio data may then be sent to the output blocks, and the video may be sent to a display engine. Additionally, Record data may be sent to Record functions such as, for example, the Record software 416. The RAVE may be, for example, a data transport processor such as, the data transport processor 405. In an embodiment of the present invention, the transport stream may comprise Record data, and audio/video data.

FIG. 5 illustrates a block diagram of the path of packets in an exemplary RAVE, in accordance with an embodiment of the present invention. The RAVE 500 may comprise a hardware assist block 505, a firmware block 510, and a memory block 550. The input 525 may comprise data, where the data may comprise packets of video, audio, and Record data. An input packet 525 may be received by the hardware assist 505, where some processing may take place. Packets may comprise AV data or Record data. The hardware assist 505 may partially process the received packet 525 and determine whether the packet comprises AV data or Record data.

The data within the received packet 525 may be separated into sets of DRAM buffers 530, which may be part of the memory block 550 or may comprise a memory unit separate from the memory block 550. Each set of the DRAM buffers 530 may comprise a compressed data buffer (CDB) 515 and a descriptor buffer (ITB) 520. Each set of DRAM buffers 530 may be defined as a context.

In an embodiment of the present invention, AV contexts may store one AV data stream within a context CDB, and Record contexts may store multiple PIDs within a context CDB. A Record context ITB may contain information from multiple sub-contexts associated with a Record packet.

Contexts associated with AV data may have different requirements and sizes from contexts associated with Record data. However, some users may require a system with more AV contexts than Record contexts, while others may require a system with more Record contexts than AV contexts. Most of the configurable parameters associated with the AV and Record contexts may be stored in memory. Therefore, switching between using a context for AV data and for Record data may involve only changing definitions of memory addresses.

Once the hardware assist 505 determines the type of data associated with a received packet, the hardware assist 505 may update configurables associated with the determined type. The firmware 510 may then access the configurables associated with a context to set up the correct channel, and consequently send the context to the intended destination, i.e., decoders 540 for AV contexts or PVR engine 545 for Record contexts.

The hardware assist 505 may, for example, update a configurable in memory that may be used to determine whether a context is AV or Record and therefore whether an AV or Record channel need be used. Another configurable, for example, may be used to indicate the base address of all configurables associated with AV contexts or Record contexts. When, for example, a channel is a Record channel, the configurables associated with Record channels may be pulled from memory at the designated location plus a Record channel offset size. Since an address may be defined where configurables for the AV context and the configurables for the Record context begin, along with their sizes, the RAVE may be dynamically configurable to have more Record channels than AV channels or vice versa. As a result this may provide flexible mapping of channels tailored for each user of the RAVE.

Accordingly, the present invention may be realized in hardware, software, or a combination thereof. The present invention may be realized in a centralized fashion in at least one computer system, or in a distributed fashion where different elements may be spread across several interconnected computer systems. Any kind of computer system or other apparatus adapted for carrying out the methods described herein may be suited. A typical combination of hardware and software may be a general-purpose computer system with a computer program that, when being loaded and executed, may control the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system for processing a plurality of packets, said system comprising:
a first circuit for processing at least a portion of a packet, configuring parameters associated with the packet based on data type, and writing the configured parameters to memory, where the packet comprises one of: data to be decoded and data associated with a record function;
a second circuit for executing a plurality of instructions, wherein execution of said plurality of instructions causes processing the partially processed packet and configuring channels for data to be decoded and data associated with a record function based on the configured parameters, wherein the number of channels for data to be decoded and number of channels for data associated with a record function is variable.

2. The system according to claim 1, further comprising:
a memory for storing the parameters associated with the packet;
channels for transporting data to be decoded to decoders; and
channels for transporting data associated with a record function to recording engines.

3. The system according to claim 1, wherein processing a portion of the packet comprises:
determining a data type associated with the packet;
preprocessing the packet based on the data type of the packet; and
extracting information from the preprocessed packet.

4. The system according to claim 1, wherein the parameters comprise:
a parameter indicating a memory location of parameters associated with data associated with a record function;
a parameter indicating number of channels used for data associated with a record function;
a parameter indicating a memory location of parameters associated with data to be decoded; and
a parameter indicating number of channels used for data to be decoded.

5. The system according to claim 1, wherein the first circuit comprises hardware components.

6. The system according to claim 1, wherein the second circuit comprises a processor.

7. The system according to claim 1, wherein processing the partially processed packet comprises:
reading the parameters associated with the packet from a memory;
configuring a channel using the read parameters; and
outputting the processed packet on the configured channel.

8. The system according to claim 1, wherein memory registers associated with the channels are utilized with functionalities and data definitions based on the data type associated with the channels.

9. A method for processing a plurality of packets, said method comprising:
processing at least a portion of a packet at a first circuit, configuring parameters associated with the packet based on data type, and writing the configured parameters to a memory, where the packet comprises one of data to be decoded and data associated with a record function;
executing a plurality of instructions at a second circuit, wherein execution of said plurality of instructions causes processing the partially processed packet and configuring channels for data to be decoded and channels for data associated with a record function based on the configured parameters, wherein the number of channels for data to be decoded and number of channels for data associated with a record function is variable.

10. The method according to claim 9, further comprising:
storing the parameters associated with the packet;
transporting data to be decoded to decoders on a first type of channel; and
transporting data associated with a record function to recording engines on a second type of channel.

11. The method according to claim 9, wherein processing a portion of the packet comprises:
determining a data type associated with the packet;
preprocessing the packet based on the data type of the packet; and
extracting information from the preprocessed packet.

12. The method according to claim 9, wherein the parameters comprise:
a parameter indicating a memory location of parameters associated with data associated with a record function;
a parameter indicating number of channels used for data associated with a record function;
a parameter indicating a memory location of parameters associated with data to be decoded; and
a parameter indicating number of channels used for data to be decoded.

13. The method according to claim 9, wherein mainly hardware components achieve the processing of the portion of a packet.

14. The method according to claim 9, wherein a processor achieves the executing of the plurality of instructions.

15. The method according to claim 9, wherein processing the partially processed packet comprises:
reading the parameters associated with the packet from a memory;
configuring a channel using the read parameters; and
outputting the processed packet on the configured channel.

16. The method according to claim 9, further comprising utilizing memory registers with functionalities and data definitions based on the data type associated with the channels associated with the memory registers.
